(19) United States
(12) Patent Application Publication
(10) Pub. No.: US 2025/0337001 A1
(43) Pub. Date: Oct. 30, 2025

(54) SECONDARY BATTERY MANUFACTURING EQUIPMENT AND SECONDARY BATTERIES MANUFACTURED USING THE SAME

(71) Applicant: Samsung SDI Co., Ltd., Yongin-si (KR)

(72) Inventors: Min Hyung Kim, Yongin-si (KR); Chan Hoon Kim, Yongin-si (KR)

(73) Assignee: Samsung SDI Co., Ltd., Yongin-si (KR)

(21) Appl. No.: 18/964,120

(22) Filed: Nov. 29, 2024

(30) Foreign Application Priority Data
Apr. 30, 2024 (KR) 10-2024-0057469

(51) Int. Cl. H01M 10/04; H01M 50/403; H01M 50/46; H01M 50/463

(52) U.S. Cl. CPC H01M 10/0404; H01M 50/403; H01M 50/46; H01M 50/463

(57) ABSTRACT

Some embodiments provide a secondary battery manufacturing equipment and secondary batteries manufactured using the same, in which tension of a separator may be maintained constant without compensating for the tension (e.g., with a separate device). When manufacturing an electrode assembly by stacking separators in a zigzag manner, the velocity of a driving roller and a final roller may be synchronized, so that the tension of the separator may be maintained constant without a separate separator tension compensation device. By controlling the design parameters of the secondary battery manufacturing equipment, the residual amount of the separators and the instantaneously required supply amount may be minimized and kept constant even if the size of the electrode assembly varies. Accordingly, there is no need for a separate tension compensation device or length compensation device to control the tension of the separator, thereby simplifying equipment and improving cell alignment precision during high-velocity stacking.

### CROSS-REFERENCE TO RELATED APPLICATIONS

This present application claims priority to and the benefit under 35 U.S.C. § 119(a)-(d) of Korean Patent Application No. 10-2024-0057469, filed on Apr. 30, 2024, in the Korean Intellectual Property Office, the entire disclosure of which is incorporated herein by reference.

### FIELD

Embodiments of the present disclosure relate to a secondary battery manufacturing equipment and secondary batteries manufactured using the same.

### BACKGROUND

Unlike primary batteries that are not designed to be (re) charged, secondary (or rechargeable) batteries are batteries that are designed to be discharged and recharged. Low-capacity secondary batteries are used in portable small electronic devices, such as smart phones, feature phones, notebook (laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not constitute related (or the prior) art.

### SUMMARY

Embodiments of the present disclosure provide a secondary battery manufacturing equipment and a secondary battery manufactured using the same, in which the tension of a separator may be maintained constant without compensating for the tension of the separator (with a separate compensation device).

These and other aspects and features of the present disclosure will be described in or will be apparent from the following description of embodiments of the present disclosure.

A secondary battery manufacturing equipment according to some embodiments of the present disclosure, may comprise: a supply unit including a supply reel on which a separator material is wound; a driving unit including a driving motor configured to pull the separator material and a driving roller rotated by the driving motor; a dancer unit disposed between the supply unit and the driving unit configured to maintain tension of the separator material; a pair of hinge rollers disposed on a lower side of the secondary battery manufacturing equipment spaced apart from the driving roller; a pair of final rollers disposed on the lower side spaced apart from the pair of hinge rollers and configured to reciprocate in an X-axis direction to move the separator material in a zigzag manner; a stack table disposed on the lower side spaced apart from the pair of final rollers and having a clamp to which one end of the separator material is fixed; and a control unit configured to derive a residual amount of the separator material and an instantaneously required supply amount and supply length of the separator material according to moving positions of the final rollers, wherein a height h from an upper surface of the stack table to a center point of the pair of hinge rollers is set according to the residual amount and instantaneously required supply amount of the separator material, derived by the control unit.

A height k from the upper surface of the stack table to the center point of the pair of final rollers may be set according to the residual amount and instantaneously required supply amount of the separator material, calculated or derived by the control unit.

The height k from the upper surface of the stack table to the center point of the pair of final rollers may be set to a height corresponding to a same value as the residual amount and instantaneously required supply amount of the separator material, calculated by the control unit.

The height h from the upper surface of the stack table to the center point of the pair of hinge rollers and the height k from the upper surface of the stack table to the center point of the pair of final rollers may change according to a width of an electrode assembly of the secondary battery.

After the separator material is fixed to the clamp, the pair of final rollers may further comprise an electrode plate transfer unit seated on the stack table in a state of being maximally spaced apart from the clamp.

Before the electrode plate transfer unit is seated, the supply length of the separator material may be L=L₁+L₂ (where L₁ is the length of the separator material from the pair of hinge rollers to the final rollers, and L₂ is the length of the separator material from the stack table from the pair of final rollers), and after the electrode plate transfer unit is seated, L=L₁+L₃ (where L₃ is the length of the separator material from the pair of final rollers to the clamp of the stack table after the electrode plate transfer unit is seated on the stack table).

The residual amount of the separator material may be a value obtained by subtracting, from the supply length of the separator material when the pair of final rollers are located at sections where tension does not occur after changing the direction into the opposite direction of the X-axis, the supply length of the separator material when the pair of final rollers are located at the end of the X-axis direction adjacent to the clamp in a state in which the separator material is fixed to the clamp.

The residual amount of the separator material may be a value obtained by subtracting, from the supply length of the separator material when the pair of final rollers are located at the end of the X-axis direction, which is maximally spaced apart from the clamp, in a state in which the separator material is fixed to the clamp, the supply length of the separator material when changing the direction into the opposite direction of the X-axis after the electrode plate transfer unit is seated.

In addition, a secondary battery manufacturing equipment according to some embodiments of the present disclosure, may comprise: a supply unit including a supply reel on which a separator material is wound; a driving unit including a driving motor for pulling the separator material and a driving roller rotated by the driving motor; a dancer unit disposed between the supply unit and the driving unit to maintain the tension of the separator material; a pair of hinge rollers disposed on a lower side spaced apart from the driving roller; a pair of final rollers disposed on the lower side spaced apart from the pair of hinge rollers and reciprocating in the X-axis direction to move the separator material in a zigzag manner; a stack table disposed on the lower side spaced apart from the pair of final rollers and having a clamp to which one end of the separator material is fixed; and a control unit that derives the supply length of the separator material according to the moving positions of the final rollers, wherein the control unit synchronizes the velocity of the driving roller with the X-axis direction velocity of the final rollers by deriving the supply velocity of the separator material through the supply length of the separator material.

The control unit may synchronize the velocity of the driving roller with the X-axis direction velocity of the pair of final rollers by applying the supply velocity of the separator material to the velocity profile of the driving roller.

The supply velocity of the separator material over time, Vₛ(t), may be

$$Vs ( t ) = Δ L ( t ) / Δ t = \frac{L ( {t}_{2} ) - L ( {t}_{1} )}{{t}_{2} - {t}_{1}} ,$$

in which before an electrode plate transfer unit is seated, L(t)=L₁(t)+L₂(t) (where t is the time, L₁ is the length of the separator material from the pair of hinge rollers to the pair of final rollers, and L₂ is the length of the separator material from the stack table from the pair of final rollers), and after the electrode plate transfer unit is seated, L(t)=L₁(t)+L₃(t) (where L₃ (t) is the length of the separator material from the pair of final rollers to the clamp of the stack table after the electrode plate transfer unit is seated on the stack table).

The control unit may synchronize the velocity of the driving roller with the X-axis direction velocity of the pair of final rollers according to the steps of: (a) deriving the velocity profile of the pair of final rollers; (b) deriving the position and swing angle of the pair of final rollers over time; (c) deriving the supply length of the separator material and the length variation over time; (d) deriving the supply velocity of the separator material; and (e) synchronizing the velocity of the driving roller with the X-axis direction velocity of the pair of final rollers by applying the supply velocity of the separator material to the velocity profile of the driving roller.

In addition, embodiments of the present disclosure may provide a secondary battery comprising: an electrode assembly manufactured by the secondary battery manufacturing equipment according to any one of the preceding aspects; a can accommodating the electrode assembly; and a cap assembly having a negative electrode terminal and a positive electrode terminal coupled to the can and electrically connected to the electrode assembly.

As described above, according to the embodiments of the present disclosure, when manufacturing an electrode assembly by stacking separators in a zigzag manner, the velocity of a driving roller and final rollers may be synchronized, so that the tension of the separators may be maintained constant without a separate separator tension compensation device. In addition, by controlling the design parameters of the secondary battery manufacturing equipment, the residual amount of the separators and the instantaneously required supply amount may be minimized and maintained constant even if the size of the electrode assembly varies.

Accordingly, there is no need for a separate tension compensation device or length compensation device to control the tension of the separators, thereby simplifying equipment and improving cell alignment precision during high-velocity stacking.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic diagram briefly showing a secondary battery manufacturing equipment according to some embodiments of the present disclosure.

FIG. 2 is an enlarged schematic diagram of some parts of the secondary battery manufacturing equipment according to FIG. 1.

FIG. 3 is a schematic diagram showing an exemplary electrode assembly.

FIGS. 4 and 5 are schematic diagrams briefly showing the positional relationship between various components in FIG. 2.

FIGS. 6A to 6E are schematic diagrams showing the positional relationship between various components of final rollers according to FIG. 2.

FIG. 7 is a graph showing the supply length of the separator for each position of the final rollers according to FIG. 2.

FIG. 8 is a graph showing the variation in the supply length of the separator according to the variation in the size of the electrode assembly according to FIG. 7.

FIGS. 9A to 9D are schematic diagrams showing sections where prediction of the variation in the supply length of the separator for each position of the final rollers according to FIG. 2 is required.

FIGS. 10 and 11 are graphs showing some factors affecting the supply length of the separator in the secondary battery manufacturing equipment according to some embodiments of the present disclosure.

FIG. 12 is a graph showing exemplary velocity profiles in velocity variables of final rollers.

FIG. 13 is a flowchart briefly showing a method for synchronizing the X-direction velocities of a driving roller and final rollers in the secondary battery manufacturing equipment according to some embodiments of the present disclosure.

FIGS. 14 and 15 are graphs showing a synchronization method using the exemplary velocity profile according to FIGS. 12 and 13.

FIGS. 16 and 17 are schematic diagrams showing an electrode assembly manufactured by the secondary battery manufacturing equipment according to some embodiments of the present disclosure.

FIG. 18 is a perspective view of an exemplary secondary battery to which the electrode assembly of FIG. 17 is applied.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

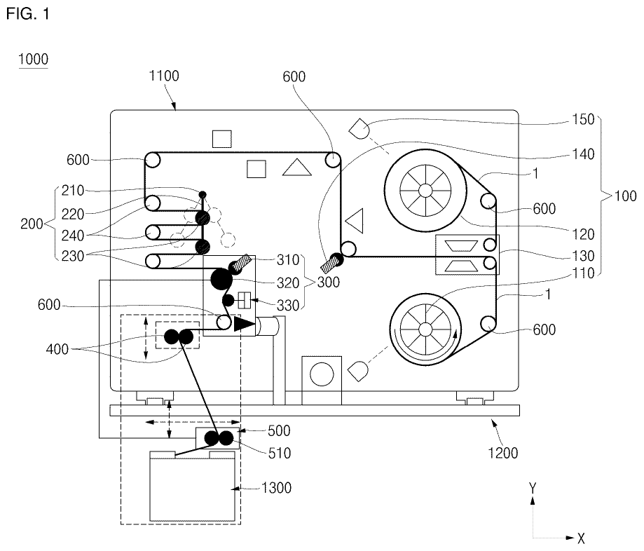

Hereinafter, a secondary battery manufacturing equipment according to embodiments of the present disclosure will be described in detail with reference to the accompanying drawings (for simplicity, the up, down, left, and right directions are described based on a main body frame of FIG. 1).

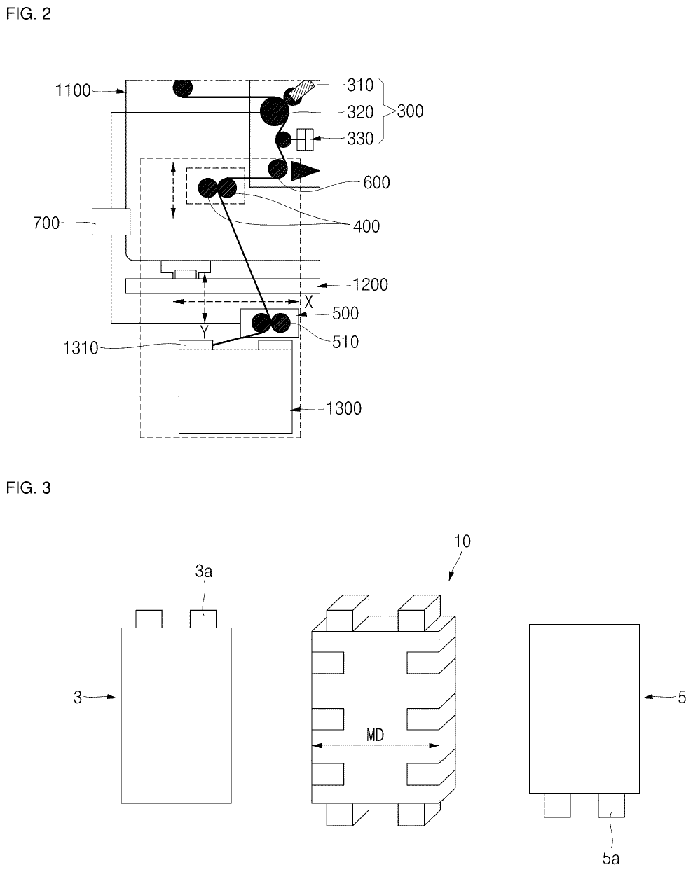

FIG. 1 is a schematic diagram briefly showing a secondary battery manufacturing equipment according to some embodiments of the present disclosure. FIG. 2 is an enlarged schematic diagram of some parts, which may be main parts, of the secondary battery manufacturing equipment according to FIG. 1.

Referring to FIGS. 1 and 2, a secondary battery manufacturing equipment 1000 according to some embodiments of the present disclosure may include a supply unit 100 for supplying a separator material 1, a dancer unit 200, a driving roller unit 300, a pair of hinge rollers 400, a final roller unit 500, and a plurality of support rollers 600 for supporting and changing the direction of the separator material 1. The support rollers 600 may be disposed adjacent to the supply unit 100, the dancer unit 200, the driving roller unit 300, etc., or may be included as components thereof. Since the support rollers 600 are general rollers of which the positions are fixed and rotate, detailed descriptions thereof will be omitted. In addition, the secondary battery manufacturing equipment 1000 may include a control unit 700 for control. The above-described components may be fixedly or rotatably installed on a main body frame 1100 arranged vertically on a main body table 1200 using various coupling mechanisms.

Additionally, the secondary battery manufacturing equipment 1000 may include a stack table 1300 installed on a lower side of the main body table 1200 on which electrode assemblies 10 are stacked. Although not shown in the drawing, an electrode plate supply unit that supplies positive and negative electrode plate materials may be provided adjacent to the stack table 1300.

The supply unit 100 may include a supply reel 110 on which a membrane-shaped separator material 1 having a predetermined width and length is wound and a replacement reel 120, an automatic replacement unit 130 for automatic replacement of the material, an unwinding motor (not shown), a stopper 140 for preventing material movement during automatic material replacement, a reel radius sensor 150 for measuring the residual amount of the separator material 1, etc.

The supply reel 110 may have the separator material 1 wound thereon, and as the supply reel 110 rotates, the separator material 1 is unwound and supplied to other units through the support rollers 600. Unwinding of the separator material 1 may be accomplished by an unwinding motor controlled by a control signal from the control unit 700. Although not shown in the drawing, the unwinding motor may be directly connected to the supply reel 110 and the replacement reel 120, respectively. When the separator material 1 wound on the supply reel 110 decreases, the radius of the supply reel 110 decreases. The reel radius sensor 150 may detect the radius of the supply reel 110, and a separate controller (not shown) or the control unit 700 to be described later may analyze the residual amount and supply amount of the separator material 1. When all of the separator material 1 wound on one supply reel 110 is used up, the supply subject can be changed to the replacement reel 120 by the automatic replacement unit 130.

During the automatic replacement of the material, the material may be replaced in a fixed state by the stopper 140. Since the specific structure of the automatic replacement unit 130 may be configured according to techniques known to those skilled in the art, detailed description thereof will be omitted. The separator material 1 supplied from the supply unit 100 may be supplied to the dancer unit 200 through the plurality of support rollers 600. By way of example, the supply unit 100 may be placed on the right side of the main body frame 1100.

The dancer unit 200 functions to adjust the tension in which the separator material 1 is supplied. The dancer unit 200 may maintain the tension of the separator material 1 at a constant level by buffering a difference between the velocity at which the separator material 1 is pulled by the driving motor, which will be described later, and the velocity at which the separator material 1 is unwound by the unwinding motor. By way of example, the dancer unit 200 may be placed on the left side of the main body frame 1100.

The dancer unit 200 may include a rotation bar 220, one end of which is rotatably supported on a rotation axis 210 and the other end of which reciprocates in the X-axis direction, a plurality of first sheaves 230 provided on the rotation bar 220, and a plurality of second sheaves 240 that are fixedly installed and spaced apart from the rotation path of the rotation bar 220. The separator material 1 passes through the first sheaves 230 and second sheaves 240 in a zigzag manner and may then be supplied to the driving roller unit 300. If the unwinding velocity of the separator material 1 in the supply reel 110 is less than the velocity at which the separator material 1 is pulled by the driving motor, the first sheaves 230 are pulled toward the second sheaves 240. Accordingly, the other end of the rotation bar 220 rotates toward the second sheaves 240 and the tension of the separator material 1 is maintained. Conversely, if the velocity of unwinding from the supply reel 110 is greater than the velocity at which the separator material 1 is pulled by the driving motor, the tension of the separator material 1 is maintained as the rotation bar 220 rotates in a direction in which the first sheaves 230 move away from the second sheaves 240, as indicated by the dashed outlines shown in FIG. 1.

The driving roller unit 300 may include a driving motor 310 and a driving roller 320 driven by the driving motor. Additionally, the driving roller unit 300 may include a mini dancer 330 and a support roller 600 for additional tension control. By way of example, the driving roller unit 300 may be placed below the dancer unit 200. The driving motor may serve to pull the separator material 1 that is unwound from the supply reel 110. Although not shown in the drawing, the driving motor may be directly connected to the driving roller 320. The driving motor may be in contact with the driving roller 320 (that is position-fixed and rotates) to rotate the driving roller 320. The driving roller 320 may be provided to control the supply velocity of the separator material 1 according to the rotation velocity. The mini dancer 330 may be provided between the driving roller 320 and the support roller 600 disposed below the driving roller 320. In some embodiments, the dancer unit may be disposed between the supply unit and driving unit. The mini dancer 330 may maintain the tension of the separator material 1 by moving to the left and right sides in the X-axis direction according to changes in the velocity of the driving motor. The rotation velocity of the driving motor may be controlled by the control unit 700.

The hinge rollers 400 may be placed close to the lower left side of the main body frame 1100. By way of example, the hinge rollers 400 may be spaced diagonally from the lower side of the driving roller unit 300. The hinge rollers 400 may be provided as a pair of rollers rotatably fixed on the main body frame 1100. The pair of hinge rollers 400 may have the same size or different sizes. The separator material 1 that has passed through the driving roller unit 300 may be caught between the pair of hinge rollers 400 and supplied to the stack table 1300. The final roller unit 500 may be installed between the main body table 1200 and the stack table 1300. The stack table may be disposed on a lower side spaced apart from the final roller unit.

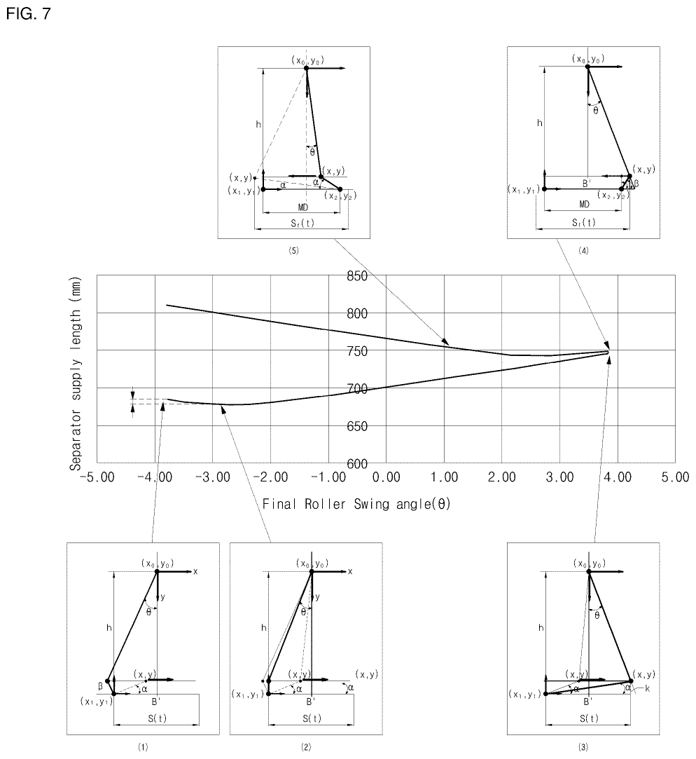

The final roller unit 500 may include a pair of final rollers 510, on which the separator material 1 can be caught, and a driving unit (not shown) that moves the final rollers 510 to the left and right sides in the X-axis direction. Through the driving unit, the final rollers 510 may linearly reciprocate along the X-axis direction below the main table 1200. According to the X-axis direction velocity of the final rollers 510, the supply velocity of the separator material 1, by the driving roller 320, may be synchronized. The final rollers may be disposed on a lower side spaced apart from the hinge rollers. The movement range of the final rollers 510 may be set according to the widths of the electrode assemblies 10 (as described in relation to FIG. 7). By way of example, the separator material 1 may enter between the pair of hinge rollers 400 from the upper left side of the hinge rollers 400, be caught on the hinge rollers 400, and then enter between the pair of final rollers 510. The separator material 1 that has passed through the final rollers 510 may be further unwound so that an end thereof may be fixed to one side of the upper surface of the stack table 1300. In this state, the driving roller 320 can be driven to pull the separator material 1, and the final rollers 510 can reciprocate in the X-axis direction to stack and/or move the separator material 1 in a zigzag manner. The electrode assemblies 10 are formed by alternately placing negative electrode plates and positive electrode plates between separator materials 1 stacked in a zigzag manner. This will be described later.

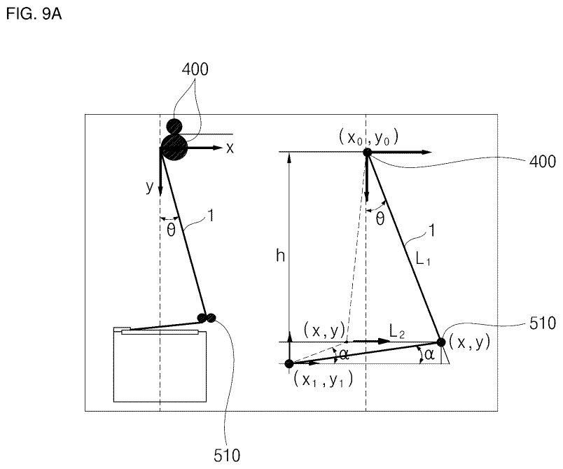

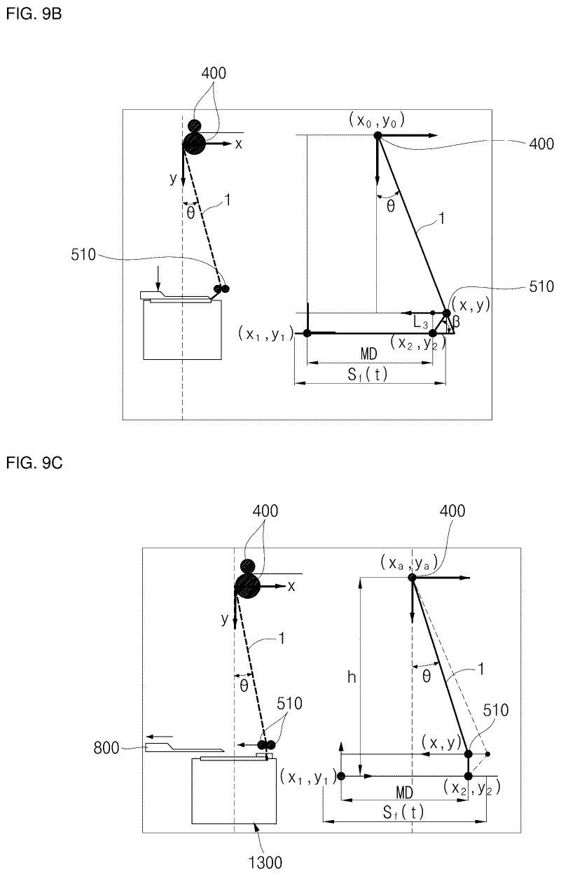

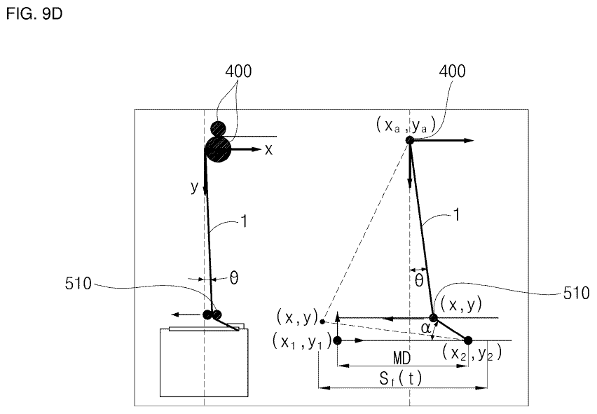

The stack table 1300 may be a workbench where the separator material 1 and electrode plate materials are stacked to form the electrode assemblies 10. The stack table 1300 may be placed below the main body table 1200 and below the final roller unit 500. By way of example, the stack table 1300 may be placed at the lower left corner of the main body table 1200, which merely corresponds to the arrangement of the aforementioned units but is not limited to the aforementioned positions. The stack table 1300, as shown, is a table that can move up and down in the Y-axis direction. As the thicknesses of the electrode assemblies 10 increase while stacking the separator material 1 and the electrode plate materials, the stack table 1300 is operated to gradually descend. Accordingly, the materials or the electrode assemblies 10 do not collide with the main body table 1200 or the final roller unit 500. Clamps 1310 that secure the ends of the separator material 1 may be provided on both sides of the upper surface of the stack table 1300 (in order to represent the left and right movement of each component in the drawing, for simplicity, only one clamp is shown). A pair of electrode plate transfer units 800 that transfer positive and negative electrode plates, respectively, may be installed adjacent to the stack table 1300 (see FIG. 9B, in order to represent the left and right movement of each component in the drawing, for simplicity, only one clamp is shown). By the electrode plate transfer units 800, the negative electrode plate 3 and the positive electrode plate 5 may be alternately placed between the separator materials 1. Since the negative electrode plate 3 or the positive electrode plate 5 is placed on the separator material 1, the separator material 1 may be temporarily fixed until the final rollers 510 change the swing direction.

The secondary battery manufacturing equipment 1000 according to some embodiments of the present disclosure may be constructed such that the final rollers 510 reciprocate along the X-axis direction. Therefore, the tension of the separator material 1 varies depending on the positions of the final rollers 510. In addition, sections where tension does not instantaneously occur at the positions where the final rollers 510 change the direction may periodically appear. Even at the sections where there is no instantaneous tension, the supply of the separator material 1 is carried out without interruption. Therefore, if the supply length of separator instantaneously exceeds the length of separator to be laminated, a meander or zigzag shape may be yielded when the separator material 1 is stacked. Accordingly, the alignment precision of the separator material 1 deteriorates, causing cell deformation and deterioration of cell quality. To solve these problems, in general, a separate separator length compensation device or additional tension control devices may be used, or a device that moves the stack table up, down, left, and right may be used. However, these additional devices may cause equipment complexity and require additional costs. In addition, when a stack table is directly moved, the problem of cell alignment precision deterioration still remains. Therefore, the present embodiments propose a method of adjusting the supply length of the separator material 1 according to changes in the tension of the separator material 1 without a separate tension control device or a stack table moving device.

Hereinafter, a method for controlling the supply velocity of the separator material 1 according to the tension of the separator material 1 by predicting the residual amount and required supply amount of the separator material 1 in advance, and minimizing the change in the tension of the separator material 1, and parameters affecting the controlling method, will be described in detail.

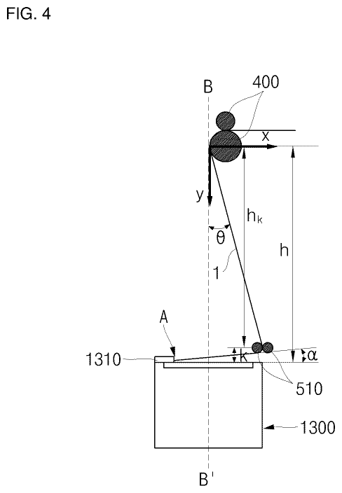

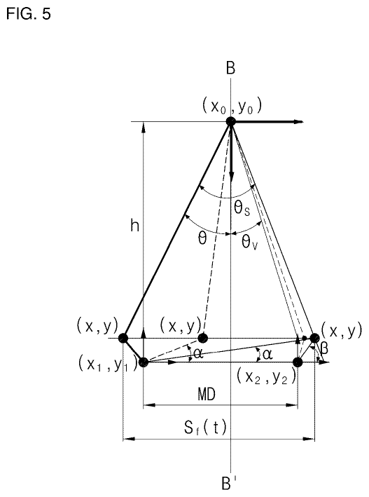

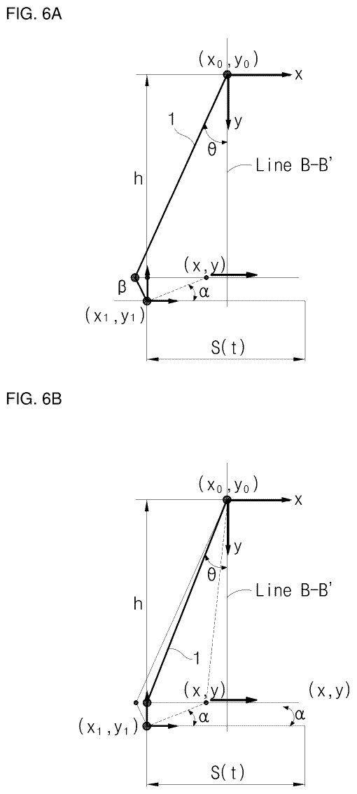

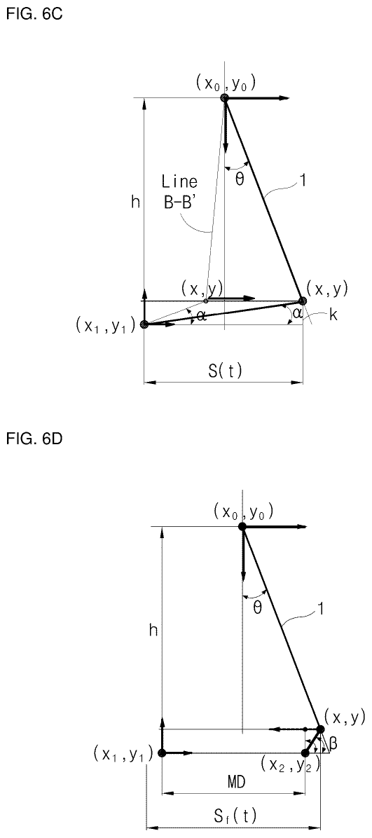

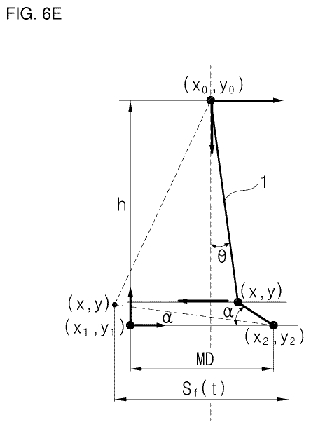

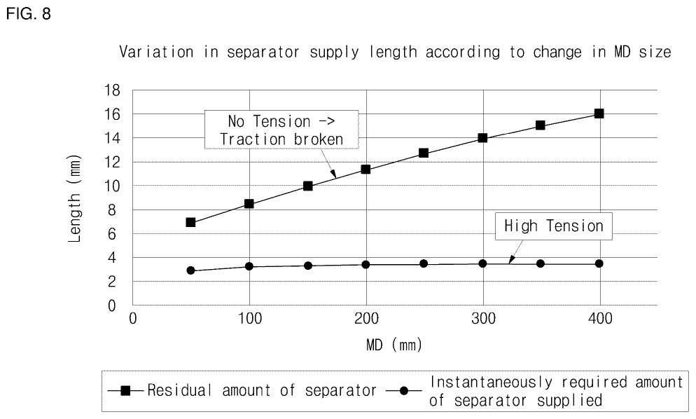

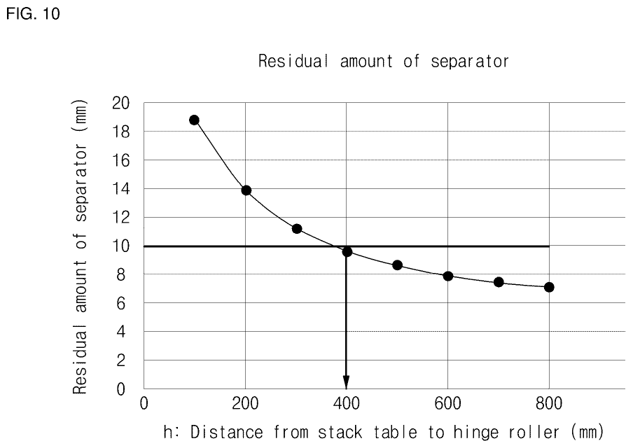

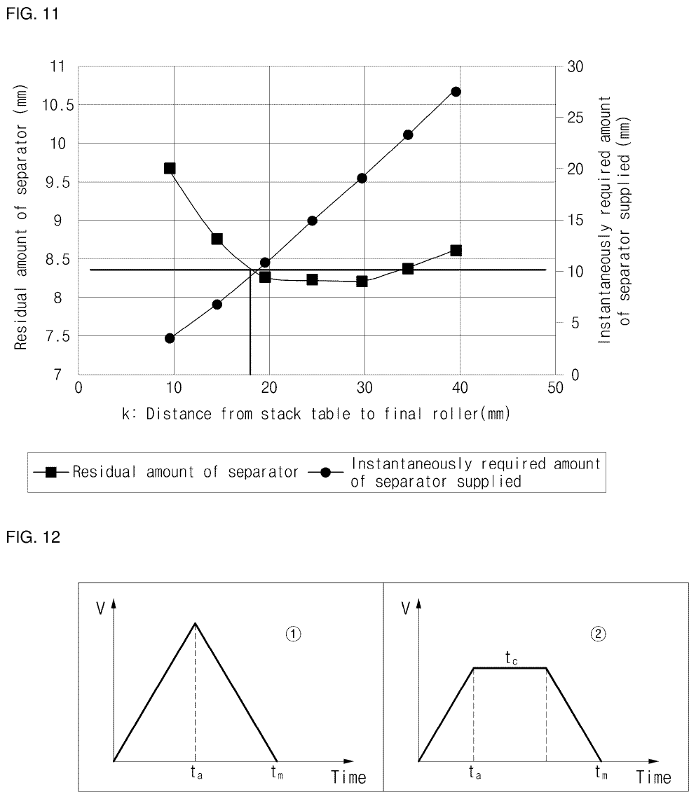

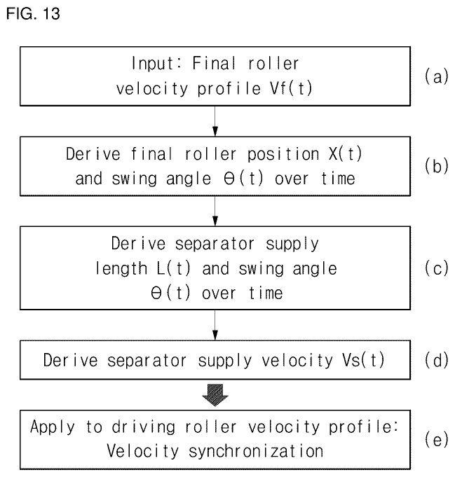

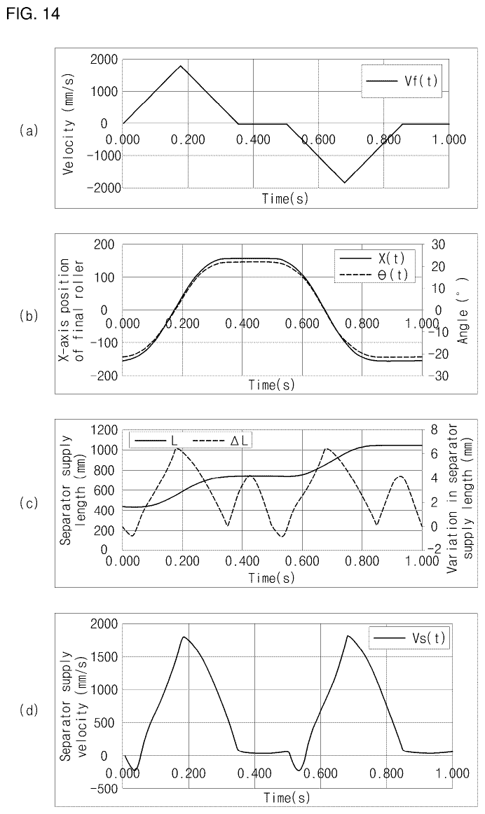

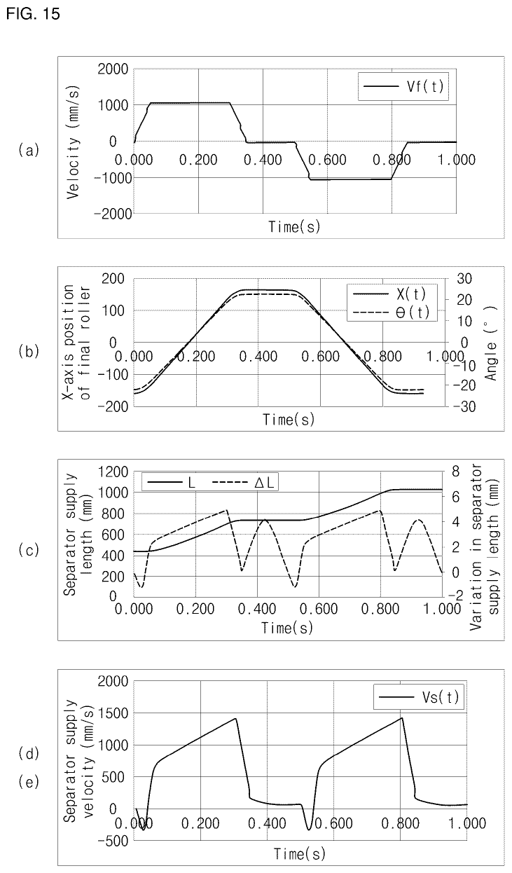

FIG. 3 is a schematic diagram showing an exemplary electrode assembly. FIG. 4 is a schematic diagram briefly showing the positional relationship between various components in FIG. 2. FIG. 5 is another schematic diagram briefly showing the positional relationship between various components in FIG. 2. FIGS. 6A to 6E are schematic diagrams showing the positional relationship between various components of final rollers according to FIG. 2. FIG. 7 is a graph showing the supply length of the separator for each position of the final rollers according to FIG. 2. FIG. 8 is a graph showing the variation in the supply length of the separator according to the variation in the size of the electrode assembly according to FIG. 7. FIGS. 9A to 9D are schematic diagrams showing sections where prediction of the variation in the supply length of the separator for each position of the final rollers according to FIG. 2 is required. FIGS. 10 and 11 are graphs showing some factors, which may be major factors, affecting the supply length of the separator in the secondary battery manufacturing equipment according to some embodiments of the present disclosure. FIG. 12 is a graph showing an exemplary velocity profile among velocity variables of final rollers. FIG. 13 is a flowchart briefly showing a method for synchronizing the X-direction velocities of a driving roller and final rollers in the secondary battery manufacturing equipment according to some embodiments of the present disclosure. FIGS. 14 and 15 are graphs showing a synchronization method using the exemplary velocity profile according to FIGS. 12 and 13.

First, the control subject of the controlling method to be described below is the control unit 700. For simplicity, the location of the control unit 700 is shown in FIG. 2, but the installation location of the control unit 700 is not limited to the location shown. The control unit 700 (or controller) and/or other related devices or components, according to the present disclosure, may be implemented by using any suitable hardware, firmware (e.g., application specific semiconductor), software, or a suitable combination of software, firmware, and hardware. For example, the control unit 700 (controller) and/or other related devices or components, according to the present disclosure, may be formed on a single integrated circuit chip, or separate integrated circuit chips. In addition, various components of the control unit 700 may be implemented on a flexible printed circuit film, and may be formed on a substrate identical to a tape carrier package, a printed circuit board, or a control unit (controller). In addition, various components of the control unit 700 may be a process or thread running in one or more computing devices, which may execute computer program commands and interact with other components to perform various functions to be mentioned below. The computer program commands are stored in a memory that can be executed on a computing device using a standard memory device, such as a random access memory. The computer program commands may also be stored in other non-transitory computer readable media, such as CD-ROMs or flash drives. Furthermore, a person skilled in the art will recognize that functions of various computing devices may be interlinked or incorporated into one computing device, or functions of a particular computing device may be dispersed to one or more other computing devices without deviating from example embodiments of the present disclosure. For example, the control unit 700 according to the present disclosure may be operated on a typical commercial computer including a central processing unit, a large-capacity storage device such as a hard disk or a solid-state disk, a volatile memory device, an input device such as a keyboard or a mouse, and an output device such as a monitor or a printer.

Next, various parameters will be briefly described.

FIG. 3 shows an exemplary electrode assembly 10 manufactured by the secondary battery manufacturing equipment 1000 according to some embodiments of the present disclosure. The electrode assembly 10 is formed by inserting a negative electrode plate 3 and a positive electrode plate 5 between separator materials 1 stacked in a zigzag shape, which will be described later. By way of example, the negative electrode plate 3 and the positive electrode plate 5 may be arranged so that a negative electrode substrate tab 3a and a positive electrode substrate tab 5a are in opposite directions. In the present embodiments, the width in the direction perpendicular to the longitudinal direction of the electrode assembly 10 is defined as MD (unit: millimeter (mm)). Since the negative electrode plate 3 and the positive electrode plate 5 may be inserted between the separator materials 1, MD may also be considered the width of the separator. In this regard, the thickness of the negative electrode plate 3 or the positive electrode plate 5 is defined as t (unit: mm). By way of example, the thickness of the separator material 1 may be approximately 0.01t, and the thickness of the negative electrode plate 3 or the positive electrode plate 5 may be approximately 0.2t. Therefore, the following description will be made in consideration of only the thickness of the electrode plate without separately considering the thickness of the separator material 1.

Referring to FIGS. 4 and 5, one end of the separator material 1 is fixed to the stack table 1300 in order to manufacture the electrode assembly 10. The position of the end of the fixed separator material 1 is shown as point A. The height from the upper surface of the stack table 1300 where the separator material 1 is stacked to the center point of the hinge rollers 400 is defined as h (unit: mm). The distance (h−k) from the center of the hinge rollers 400 to the center of the final rollers 510 is defined as hₖ (unit: mm). Based on the reference line (line B-B′) passing through ½ of the width MD of the electrode assembly 10 on the stack table 1300, the angle between the reference line B-B′ and the final rollers 510 (the angle formed between the separator materials connected from the hinge rollers to the final rollers) is defined as θ. The stroke of the final rollers 510 (maximum moving distance of the final rollers along the X-axis direction, unit: mm) is defined as Sₜ. The vertical height from the upper surface of the stack table 1300 to the center of the final rollers 510 is defined as k. Based on point A, the angle formed between the upper surface of the stack table 1300 and the final rollers 510 is defined as α. Point A, which is the contact point between the hinge roller 400 and the separator material 1, and the positions of the final roller 510 (more precisely, the position of the separator material in contact with the pair of final rollers), may be expressed as coordinates (xn, yn) based on the same X and Y axes as in FIG. 1. In the drawings of the present embodiments, (x₀, y₀) is the positions of the hinge rollers 400, (x, y) is the positions of the final rollers 510, (x₁, y₁) is the starting coordinate (point A coordinate) of the separator material 1 when the final rollers 510 are on the left side of the stack table 1300, and (x₂, y₂) represents the starting coordinates of the separator material 1 (which means the starting point position when changing the direction of the final rollers) when the final rollers 510 are on the right side of the stack table 1300. In addition, the diameter of the final rollers 510 is defined as FD (unit: mm). The total of the X-axis swing angle of the final rollers 510 is defined as θS, and when the final rollers 510 are at the same position as the right end of MD, the angle with respect to the reference line B-B′ is defined as θ_{V}. Here, based on the right end position of MD, the angle between the upper surface of the stack table 1300 and the final rollers 510 is defined as B (the reason the location of the right end of the MD is used as a reference is because the end of the electrode plate supply unit is placed at the corresponding location). Additionally, the thickness of the electrode plate transfer unit 800 is defined as Pt (unit: mm), the safety distance from the bottom of the final rollers 510 to the stack table 1300 is defined as Dₛ (unit: mm), and the safety distance from the final rollers 510 to the electrode plate transfer unit 800 is defined as Fₛ (unit: mm).

FIG. 6A shows the positions of the final rollers 510 and the state of the separator material 1 when the final rollers 510 are located at the left end of the entire swing range (state (1) in FIG. 7). FIG. 6B shows the positions of the final rollers 510 and the state of the separator material 1 immediately after the final rollers 510 change the direction from the left end to the right (state (2) in FIG. 7). FIG. 6C shows the positions of the final rollers 510 and the state of the separator material 1 when the final rollers 510 are located at the right end of the entire swing range (state (3) in FIG. 7). FIG. 6D shows the positions of the final rollers 510 and the state of the separator material 1 after the electrode plate transfer units 800 are seated on the stack table 1300 (state (4) in FIG. 7). FIG. 6E shows the positions of the final rollers 510 and the state of the separator material 1 immediately after the electrode plate transfer units 800 leave the stack table 1300 and the final rollers 510 change the direction from the right end to the left (state (5) in FIG. 7).

Among the aforementioned parameters, MD and t are product variables, h, k, F_{D}, Pt, Dₛ, Fₛ, θ, θ_{L} (θ_{L}=−θ_{S}/2 as the angle when the final rollers are at the left end), and θ_{R} (θ_{R}=θ_{S}/2 as the angle when the final rollers are at the right end) are electrode assembly stack design variables. By using these as input parameters (input variables), the separator supply length according to the overall swing angle θ of the final rollers 510 shown in FIG. 7 may be derived (e.g., by the control unit).

First, the output parameters (output variables) may be derived by using the above-mentioned input parameters with the formulas as follows:

$$k = Fd / 2 + Pt + t + {D}_{s} ; \qquad ( Formula 1 )$$

$${h}_{k} = h - k ; \qquad ( Formula 2 )$$

$${S}_{f} = MD + {F}_{d} + {F}_{s} ; \qquad ( Formula 3 )$$

$${Θ}_{s} = 2 \times {tan}^{- 1} ( \frac{{S}_{f}}{2 \times {h}_{k}} ) ; \qquad ( Formula 4 )$$

$${Θ}_{V} = {tan}^{- 1} ( \frac{MD}{2 \times {h}_{k}} ) ; \qquad ( Formula 5 )$$

$${X}_{1} = - MD / 2 ; \qquad ( Formula 6 )$$

$${Y}_{1} = h ; \qquad ( Formula 7 )$$

$${X}_{1} = - MD / 2 ; and \qquad ( Formula 8 )$$

$${Y}_{2} = h . \qquad ( Formula 9 )$$

Exemplary values of the respective parameters may be as follows in Table 1 and Table 2:

TABLE 1

| | |
|---|---|
| h | 677 |
| k | 9.5 |
| hₖ | 667.5 |
| MD | 64.8 |
| F_{D} | 12 |

TABLE 2

| | |
|---|---|
| S_{f} | 88.8 |
| Θs | 7.6 (Final Roller Swing Angle) |
| ΘL | −3.8 ΘL = −Θs/2 (Final Roller Swing Left Angle) |
| ΘR | 3.8 ΘR = Θs/2 (Final Roller Swing Right Angle) |
| X₁ | −32.4 |
| Y₁ | 677.0 |
| X₂ | 32.4 |
| Y₂ | 677.0 |
| Θ_{z} | 2.78 |

The positions (X, Y) of the final rollers 510 for the respective swing angles of the hinge rollers 400 and the final rollers 510 may be derived as follows:

$$X = {h}_{k} \times tan ( Θ ) , Y = {h}_{k} . \qquad ( Formula 10 )$$

After the separator material 1 is fixed to the clamps 1310 of the stack table 1300, the variation in the angle (α) formed between the upper surface of the stack table 1300 and the final rollers 510 for moving positions of the final rollers 510 may be derived as follows:
when the final rollers 510 move to the right, as shown in FIG. 6C (or FIG. 9A),

$$α = {tan}^{- 1} ( \frac{k}{X - {X}_{1}} ) = {tan}^{- 1} ( \frac{k}{{h}_{k} tan θ - {X}_{1}} ) ; \qquad ( Formula 11 )$$

and
when the final rollers 510 move to the left, as shown in FIG. 6E (or FIG. 9D),

$$α = - {tan}^{- 1} ( \frac{k}{X - {X}_{2}} ) = - {tan}^{- 1} ( \frac{k}{{h}_{k} tan θ - {X}_{2}} ) . \qquad ( Formula 12 )$$

In addition, after the electrode plate transfer unit 800 is seated on the stack table 1300, the variation in the angle (B) formed between the upper surface of the stack table 1300 and the final rollers 510 for the respective moving positions of the final rollers 510 may be derived as follows:
when the final rollers 510 move to the right (here, the electrode plate supply part is seated and does not move any further in a state in which the final rollers moved to the right as much as possible):

$$β = - {tan}^{- 1} ( \frac{k}{X - {X}_{1}} ) = - {tan}^{- 1} ( \frac{k}{{h}_{k} tan θ - {X}_{1}} ) ; \qquad ( Formula 13 )$$

and
when the final rollers 510 move to the left, as shown in FIG. 6D (or FIG. 9B):

$$β = {tan}^{- 1} ( \frac{k}{X - {X}_{2}} ) = {tan}^{- 1} ( \frac{k}{{h}_{k} tan θ - {X}_{2}} ) . \qquad ( Formula 14 )$$

In addition, the supply length of the separator material according to the moving position of the separator material 1 may be calculated as follows:
before the electrode plate transfer unit 800 is seated on the stack table 1300:

$$L = {L}_{1} + {L}_{2} ; \qquad ( Formula 15 )$$

and
after the electrode plate transfer unit 800 is seated on the stack table 1300:

$$L = {L}_{1} + {L}_{3} . \qquad ( Formula 16 )$$

Here, L₁ is the length of the separator material 1 from the hinge rollers 400 to the final rollers 510 (unit: mm), L₂ is the length of the separator material 1 from the final rollers 510 to the clamps 1310 of the stack table 1300 (unit: mm), and L₃ is the length of the separator material 1 from the final rollers 510 to the clamps 1310 of the stack table 1399 after the electrode plate transfer unit 800 is seated on the stack table 1300 (unit: mm).

In addition, the supply length for each swing angle (θ) of the final rollers 510 of the length L₁ of the separator material 1 from the hinge rollers 400 to the final rollers 510 may be derived as follows:

$${L}_{1} = \frac{{h}_{k}}{cos θ} = \sqrt{{X}^{2} + {Y}^{2}} . \qquad ( Formula 17 )$$

The supply length for each swing angle (θ) of the final rollers 510 of the length L₂ of the separator material 1 from the final rollers 510 to the clamps 1310 of the stack table 1300 may be derived by applying Formula 10 as follows:
when the final rollers 510 initially move to the right:

$${L}_{2} = \sqrt{{( X - {X}_{1} )}^{2} + {( Y - {Y}_{1} )}^{2}} = \sqrt{{( {h}_{k} tan θ - {X}_{1} )}^{2} + {k}^{2}} . \qquad ( Formula 18 )$$

After the electrode plate transfer unit 800 is seated on the stack table 1300, the supply length for each swing angle (θ) of the separator material 1 of the length L₃ of the separator material 1 from the final rollers 510 to the clamps 1310 of the stack table 1300 may be derived by applying Formula 14 as follows:
when the final rollers 510 move to the left:

$${L}_{3} = MD + \frac{k}{sin β} = MD + \frac{k}{sin ( - {tan}^{- 1} ( \frac{k}{{h}_{k} tan θ - {X}_{2}} ) )} . \qquad ( Formula 19 )$$

By applying Formulas 15 to 19, the supply length for each swing angle (θ) of the final rollers 510 may be calculated as follows:
before the electrode plate transfer unit 800 is seated on the stack table 1300:

$$L = {L}_{1} + {L}_{2} = \frac{{h}_{k}}{cos θ} + \sqrt{{( {h}_{k} tan θ - {X}_{1} )}^{2} + {k}^{2}} ; \qquad ( Formula 15 - 1 )$$

and
after the electrode plate transfer unit 800 is seated on the stack table 1300:

$$L = {L}_{1} + {L}_{3} = \frac{{h}_{k}}{cos θ} + MD + \frac{k}{sin ( - {tan}^{- 1} ( \frac{k}{{h}_{k} tan θ - {X}_{2}} ) )} . \qquad ( Formula 16 - 1 )$$

The thus derived supply length of the separator material 1 for each swing angle (θ) of the final rollers 510 is shown in FIG. 7. State (1) in FIGS. 6A and 7 is when the separator material 1 is fixed to the clamps 1310 of the stack table 1300 and the final rollers 510 are at the leftmost position in the swing angle range. In state (1), the final rollers 510 are pushing the separator material 1 to the left. Thereafter, state (2) in FIGS. 6B and 7 is when the final rollers 510 turn to the right and begin to move. At this position, the force of the final rollers 510 pushing the separator material 1 to the left disappears, and thus the residual amount of the separator material 1 is instantaneously generated, resulting in no tension (the residual amount of the separator material 1 may be derived by subtracting the supply length of the separator material 1 when the final rollers 510 are located at the left end in the X-axis direction from the supply length of the separator material 1 when the final rollers 510 change the direction to the right and are located in a section where tension does not occur). Thereafter, since the final rollers 510 move while pushing the separator material 1 to the right, tension is generated again in the separator material 1 and the material supply length increases. In some embodiments, the residual amount of the separator material is a value obtained by subtracting, from the supply length of the separator material when the pair of final rollers are located at sections where tension does not occur after changing direction into an opposite direction of an X-axis, the supply length of the separator material when the pair of final rollers are located at an end of the X-axis direction adjacent to the clamp in a state in which the separator material is fixed to the clamp. Further, the residual amount of the separator material may be a value obtained by subtracting, from the supply length of the separator material when the pair of final rollers are located at the end of the X-axis direction, which is maximally spaced apart from the clamp, in a state in which the separator material is fixed to the clamp, the supply length of the separator material when changing the direction into the opposite direction of the X-axis after the electrode plate transfer unit is seated.

State (3) in FIGS. 6C and 7 is when the final rollers 510 move in this state to be at the rightmost side of the swing angle range. In state (3), the states of the separator material 1, the final rollers 510, and the stack table 1300 are also shown in detail in FIG. 9A. In state (3), the separator material 1 is farthest from the clamps 1310, and the final rollers 510 push the separator material 1 to the right as much as possible, and thus the tension of the separator material 1 is highest. Thereafter, the electrode plate transfer unit 800 is seated on the stack table 1300, and the final rollers 510 begin to change the direction. This state corresponds to state (4) in FIGS. 6D and 7. In state (4), the states of the separator material 1, the final rollers 510, the stack table 1300, and the electrode plate transfer unit 800 are also shown in detail in FIG. 9B. Here, since the electrode plate transfer unit 800 is seated on the separator material 1 and the separator material 1 is temporarily fixed, and thus, even if the final rollers 510 begin to change the direction, a tension-free state is not reached. Thereafter, the electrode plate transfer unit 800 separates from the stack table 1300. FIG. 9C shows the position of the separator material and the positions of the final rollers while the electrode plate supply part is being separated. The final rollers 510 move to the left again, and the supply amount of the separator material 1 increases. This state corresponds to state (5) in FIGS. 6E and 7. In state (5), the states of the separator material 1, the final rollers 510, and the stack table 1300 are also shown in detail in FIG. 9D.

As described above, the supply of separator material 1 continues even at the position of state (2), and thus about 6.5 mm of the separator material 1 remains (residual amount of separator \textcircled{1}). If there is no tension in the separator material 1, the traction force may be broken and misalignment of the electrode assembly 10 may occur. Conversely, at the position of state (4), the tension of the separator material 1 is highest, and thus supplying about 2.7 mm of the separator material 1 is instantaneously required (instantaneously required amount of separator supplied \textcircled{2}). If the tension of the separator material 1 instantaneously increases, deformation of the separator material 1 and resulting defects in the electrode assembly 10 may occur. Therefore, the inventors have identified there is a need to solve these problems.

In general, as the size (MD) of the electrode assembly 10 increases, the residual amount (\textcircled{1}—residual amount of separator material) and the instantaneously required supply amount (\textcircled{2}) of the separator material 1 also increase. Accordingly, this causes a change in product quality of the electrode assembly 10. FIG. 8 shows changes in the residual amount (\textcircled{1}) and instantaneously required supply amount (\textcircled{2}) of the separator material 1 according to exemplary MD size changes. Here, example input parameters are as follows in Table 3:

TABLE 3

| | |
|---|---|
| h | 200 |
| k | 9.5 |
| hₖ | 190.5 |
| F_{D} | 12 |

As described above, there are several parameters that affect the supply length of the separator material 1 (L=f(hₖ, θ, MD, k), hₖ=f(h, k), k=f(F_{d}, Pt, t, Dₛ), and θ=f(MD, F_{d}, Fₛ, h, k)). However, even if the MD size of the electrode assembly 10 changes through a Y-axis direction motion of the hinge rollers 400 and the final rollers 510, the residual amount and instantaneously required supply amount of the separator material 1 are minimized or maintained constant. Hereinafter, some parameters which may be important among several parameters that affect the supply length of the separator material 1 are further described.

Among the aforementioned parameters, h, which is the height from the upper surface of the stack table 1300 to the center point of the hinge rollers 400, will first be described.

FIG. 10 shows the residual amount of the separator material 1 for each length of h in an example where MD is 300 mm, k is 9.5 mm, and the diameter FD of the final rollers 510 is 12 mm (in order to vary h, FIG. 10 was obtained by varying the positions of the hinge rollers in a state in which the stack table is fixed). Referring to FIG. 10, when MD is 300 mm or less, in order to maintain the residual amount of the separator material 1 at 10 mm or less, 400 mm or more of h is required. Here, the parameter h does not affect the instantaneously required supply amount of the separator material 1. As described above, in order to maintain the residual amount of the separator material 1 at a desired value, h may be adjusted. That is, when designing the secondary battery manufacturing equipment 1000, the residual amount of the separator material 1 may be controlled by using the parameter h. The height may be set according to the residual amount and the instantaneously required supply amount (e.g., derived by the control unit). The height may change according to the width of the electrode assembly of the secondary battery, in some embodiments.

Next, the vertical height k from the upper surface of the stack table 1300 to the center of the final rollers 510 will be described.

FIG. 11 shows the residual amount and instantaneously required amount of the separator material 1 for each length of k in an example in which MD is 300 mm, h is 400 mm, and the diameter F_{D} of the final rollers 510 is 12 mm. The k value may be increased to reduce the residual amount of the separator material 1, but in this case, the instantaneously required amount of the separator material 1 increases. Therefore, it may be necessary to find the k value where the residual amount and instantaneously required amount of the separator material 1 are equal. In order for the residual amount of the separator material 1 to be equal to the instantaneously required amount in one cycle, k must be 17 mm (here, one cycle means that the final rollers move once from the left to the right or from the right to the left). In this way, in order to maintain the residual amount and instantaneously required amount of the separator material 1 at desired values, k may be adjusted (here, the k value may be adjusted by adjusting the height of the final rollers in the Y-axis direction). That is, when designing the secondary battery manufacturing equipment 1000, the residual amount and instantaneously required amount of the separator material 1 may be controlled by using the parameter k. The height may be set according to the residual amount and the instantaneously required supply amount (e.g., derived by the control unit). The height may be set to a height corresponding to a same value as the residual amount and instantaneously required supply amount of the separator material.

In addition, the supply length of the separator material 1 may be predicted according to the X-axis direction velocity of the final rollers 510, rather than by controlling the parameters h and k, and the velocity of the driving roller 320 may be synchronized with the X-axis direction velocity of the final rollers 510. Through this control method, the supply velocity of the separator material 1 may be controlled, thereby controlling the residual amount and instantaneously required amount of the separator material 1.

FIG. 12 shows exemplary velocity profiles.

Input parameters for synchronizing the velocity of the driving roller 320 with the X-axis direction velocity of the final rollers 510 include the parameters of the final rollers 510 defined as follows:
t_{TACT}: Tact of final rollers 510 (1 cycle, unit: sec; t_{TACT}=tₜ);
tₘ: Movement time of final rollers 510 (unit: sec);
tₐ: Acceleration time of final rollers 510 (unit: sec);
t_{c}: Constant velocity time of final rollers 510 (unit: sec);
tᵣ: Standby time of final rollers 510 (unit: sec);
tₜ: 1 cycle time of final rollers 510 (unit: sec);

$${t}_{t} = {t}_{m} + {t}_{r} \qquad ( Formula 19 )$$

t: Movement time of final rollers 510 (unit: sec); and
velocity profile of final rollers 510.

If the velocity profile is a triangular profile, the output parameters are defined as follows:
V_{f}(t): X-direction velocity of final roller over time (unit: mm/s);
Vₜₘₐₓ: X-direction maximum velocity of final roller (unit: mm/s), obtained from:

$${V}_{fmax} = 2 \times {S}_{i} / {t}_{m} ; \qquad ( Formula 20 )$$

a(t): acceleration velocity of final roller over time (unit: mm/s²); and
aₘₐₓ: X-direction maximum acceleration velocity of final roller (unit: mm/s²), obtained from:

$${a}_{max} = {V}_{fmax} / ( {t}_{m} / 2 ) . \qquad ( Formula 21 )$$

If the velocity profile is a trapezoidal profile, the output parameters are defined as follows:
V_{fmax}: X-direction maximum velocity of final roller (unit: mm/s), obtained from:

$${V}_{fmax} = {S}_{i} / ( {t}_{a} + {t}_{c} ) ; \qquad ( Formula 22 )$$

aₘₐₓ: X-direction maximum acceleration velocity of final roller (unit: mm/s²), obtained from:

$${a}_{max} = {V}_{fmax} / {t}_{a} . \qquad ( Formula 23 )$$

The traveling velocity of the final rollers 510 in the X-axis direction over time may be derived as follows:

$${V}_{f} ( t ) = {V}_{t - 1} + a \times Δ t . \qquad ( Formula 24 )$$

The X-axis position of the final rollers 510 over time may be derived as follows:
when the final rollers 510 move to the right:

$$X ( t ) = {h}_{k} tan {θ}_{L} + {V}_{f} ( t ) \times \frac{t}{2} ; \qquad ( Formula 25 )$$

and
when the final rollers 510 move to the left:

$$X ( t ) = {h}_{k} tan {θ}_{R} + {V}_{f} ( t ) \times \frac{t - {t}_{t}}{2} . \qquad ( Formula 26 )$$

The variation in the swing angle of the final rollers 510 over time may be derived as follows:

$$θ ( t ) = {tan}^{- 1} \frac{X ( t )}{{h}_{k}} . \qquad ( Formula 27 )$$

After the separator material 1 is fixed to the clamps 1310 of the stack table 1300, the variation in the angle (α) formed between the upper surface of the stack table 1300 and the final rollers 510 for each moving position of the final rollers 510 may be derived as follows:
when the final rollers 510 move to the right (such as in FIG. 9A), Formula 11 may be applied as follows:

$$α ( t ) = {tan}^{- 1} ( \frac{k}{X ( t ) - {X}_{1}} ) ; \qquad ( Formula 28 )$$

and
when the final rollers 510 move to the left (such as in FIG. 9D), Formula 12 may be applied as follows:

$$α ( t ) = - {tan}^{- 1} ( \frac{k}{X ( t ) - {X}_{2}} ) . \qquad ( Formula 29 )$$

After the electrode plate transfer unit 800 is seated on the stack table 1300, which in some embodiments includes the electrode plate transfer unit being maximally spaced apart from the clamp, the variation in the angle (B) formed between the upper surface of the stack table 1300 and the final rollers 510 for each moving position of the final rollers 510 over time may be derived as follows:
when the final rollers 510 move to the right, Formula 13 may be applied as follows:

$$β ( t ) = - {tan}^{- 1} ( \frac{k}{X ( t ) - {X}_{1}} ) ; \qquad ( Formula 30 )$$

and
when the final rollers 510 move to the left (such as in FIG. 9B), Formula 14 may be applied as follows:

$$β ( t ) = {tan}^{- 1} ( \frac{k}{X ( t ) - {X}_{2}} ) . \qquad ( Formula 31 )$$

The variation in the supply length of the separator material 1 over time will now be described.

The supply length of the separator material 1 from the hinge rollers 400 to the final rollers 510 over time, L₁(t), may be derived by applying Formula 17 as follows:

$${L}_{1} ( t ) = \frac{{h}_{k}}{cos θ ( t )} = \sqrt{{X ( t )}^{2} + {Y ( t )}^{2}} . \qquad ( Formula 32 )$$

The supply length of the separator material 1 from the final rollers 510 to the stack table 1300 over time, L₂(t), may be derived as follows:
when the final rollers 510 move to the right, Formula 18 may be applied as follows:

$${L}_{2} ( t ) = \sqrt{{( X ( t ) - {X}_{1} )}^{2} + {( Y ( t ) - {Y}_{1} )}^{2}} = \sqrt{{( {h}_{k} tan {θ}_{L} + {V}_{f} ( t ) \times \frac{t}{2} - {X}_{1} )}^{2} + {k}^{2}} ; \qquad ( Formula 33 )$$

and
when the final rollers 510 move to the left, Formula 19 may be applied as follows:

$${L}_{3} ( t ) = MD + \frac{k}{sin β ( t )} = MD + \frac{k}{sin ( - {tan}^{- 1} ( \frac{k}{X ( t ) - {X}_{2}} ) )} . \qquad ( Formula 34 )$$

By applying Formulas 32 to 34, the supply length of the separator material 1 over time may be calculated as follows:
before the electrode plate transfer unit 800 is seated on the stack table 1300:

$$L ( t ) = {L}_{1} ( t ) + {L}_{2} ( t ) = \sqrt{{X ( t )}^{2} + {Y ( t )}^{2}} + \sqrt{{( X ( t ) - {X}_{1} )}^{2} + {( Y ( t ) - {Y}_{1} )}^{2}} ; \qquad ( Formula 35 )$$

and
after the electrode plate transfer unit 800 is seated on the stack table 1300:

$$L ( t ) = {L}_{1} ( t ) + {L}_{3} ( t ) = \sqrt{{X ( t )}^{2} + {Y ( t )}^{2}} + MD + \frac{k}{sin β ( t )} . \qquad ( Formula 36 )$$

The supply velocity of the separator material 1 over time, Vₛ(t), may be calculated as follows:

$$Vs ( t ) = Δ L ( t ) / Δ t = \frac{L ( {t}_{2} ) - L ( {t}_{1} )}{{t}_{2} - {t}_{1}} . \qquad ( Formula 37 )$$

By using Formula 37, the X-axis velocity of the final rollers 510 and the supply velocity of the separator material 1 over time may be obtained. By applying the thus obtained supply velocity of the separator material 1 to the velocity profile of the driving roller 320, the velocity of the driving roller 320 may be synchronized with the X-axis direction velocity of the final rollers 510.

The steps of the above-described control method are summarized and shown in FIG. 13. The velocity profile of the final rollers 510 as an input value may be derived (step (a)), the position and swing angle of the final rollers 510 over time may be derived (step (b)), and then the supply length of the separator material 1 and the variation in the length over time may be derived (step (c)). Then, the supply velocity of the separator material 1 and the variation in the length may be derived (step (d)), and the velocity of the driving roller 320 may be synchronized with the X-axis direction velocity of the final rollers 510 by applying the supply velocity of the separator material 1 (e.g., through the supply length) to the velocity profile of the driving roller 320 (step (e)). FIG. 14 shows an example of applying steps (a) to (e) when the velocity profile of the final rollers 510 is a triangular profile. FIG. 15 shows an example of applying steps (a) to (e) when the velocity profile of the final rollers 510 is a trapezoidal profile.

By using the above-described method, the residual amount and instantaneously required supply amount of a separator material may be adjusted according to changes in the tension even without a separate tension control device or movement of a stack table.

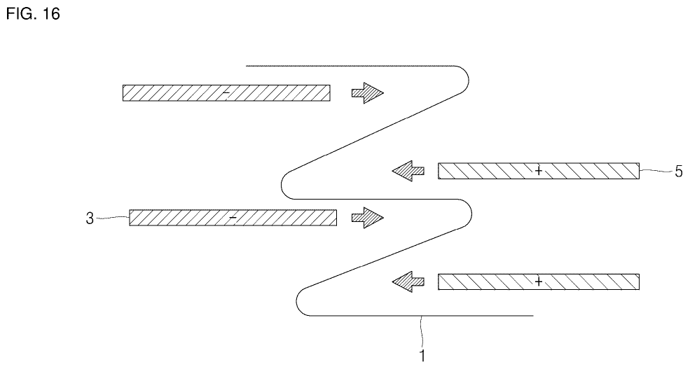

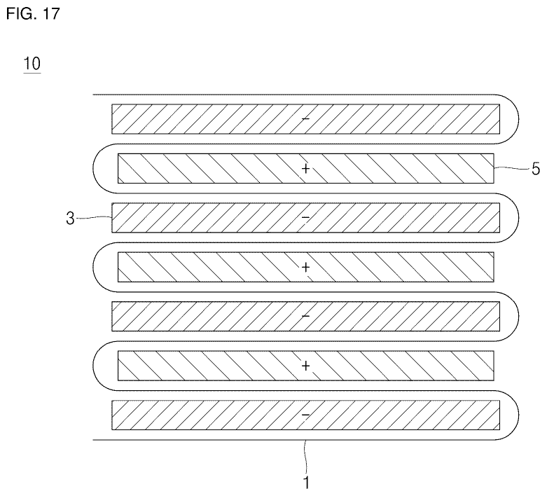

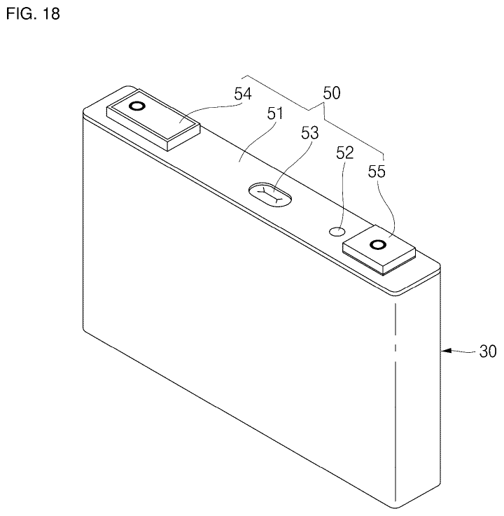

FIG. 16 is a schematic diagram showing an electrode assembly manufactured by the secondary battery manufacturing equipment according to some embodiments of the present disclosure. FIG. 17 is a schematic diagram showing an electrode assembly manufactured by the secondary battery manufacturing equipment according to some embodiments of the present disclosure. FIG. 18 is a perspective view of an exemplary secondary battery to which the electrode assembly of FIG. 17 is applied.

By the secondary battery manufacturing equipment 1000, according to some embodiments of the present disclosure, a separator material 1 may be stacked in a zigzag manner. Meanwhile, a negative electrode plate 3 and a positive electrode plate 5 may be alternately arranged, thereby completing the electrode assembly 10. The electrode assembly 10 may be accommodated in a prismatic can 30 together with an electrolyte. A cap assembly 50 including a negative electrode terminal 54 and a positive electrode terminal 55, electrically connected to the electrode assembly 10, may be coupled to one side of the prismatic can 30.

The negative electrode plate 3 may include a negative electrode substrate that is a thin metal plate, a negative electrode active material layer provided on at least one surface of the negative electrode substrate, and a negative electrode uncoated portion to which a negative electrode active material layer is not applied. The negative electrode uncoated portion may be electrically connected to the negative electrode terminal 54.

The negative electrode substrate may include copper or nickel foil, and the negative electrode active material layer may include carbon-based materials, Si, Sn, tin oxide, tin alloy composite, transition metal oxide, lithium metal nitrite, or metal oxide.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof. The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core. A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The positive electrode plate 5 may include a positive electrode substrate that is a thin metal plate, a positive electrode active material layer provided on at least one surface of the positive electrode substrate, and a positive electrode uncoated portion to which a positive electrode active material is not applied. The positive electrode uncoated portion may be referred to as a positive electrode substrate. The positive electrode uncoated portion may be electrically connected to the positive electrode terminal 55.

By way of example, the positive electrode substrate may include aluminum foil, and the positive electrode active material layer may include transition metal oxide.

Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The separator 1 may be interposed between the negative electrode plate 3 and the positive electrode plate 5 and may serve to prevent short circuit between the negative electrode plate 3 and the positive electrode plate 5. For example, the separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

While the foregoing embodiments are only some embodiments for carrying out the present disclosure, which is not limited to the exemplary embodiments, it will be understood by a person skilled in the art that various modifications and changes in form and details may be made therein within the equivalent scope of the technical idea of the present disclosure as defined by the following claims.

What is claimed is:

1. A secondary battery manufacturing equipment comprising:
a supply unit including a supply reel on which a separator material is wound;
a driving unit including a driving motor configured to pull the separator material and a driving roller rotated by the driving motor;
a dancer unit disposed between the supply unit and the driving unit configured to maintain tension of the separator material;
a pair of hinge rollers disposed on a lower side of the secondary battery manufacturing equipment spaced apart from the driving roller;
a pair of final rollers disposed on the lower side spaced apart from the pair of hinge rollers and configured to reciprocate in an X-axis direction to move the separator material in a zigzag manner;
a stack table disposed on the lower side spaced apart from the pair of final rollers and having a clamp to which one end of the separator material is fixed; and
a control unit configured to derive a residual amount of the separator material and an instantaneously required supply amount and supply length of the separator material according to moving positions of the pair of final rollers,
wherein a height h from an upper surface of the stack table to a center point of the pair of hinge rollers is set according to the residual amount of the separator material and the instantaneously required supply amount derived by the control unit.

2. The secondary battery manufacturing equipment as claimed in claim 1, wherein a height k from the upper surface of the stack table to a center point of the pair of final rollers is set according to the residual amount and instantaneously required supply amount of the separator material, derived by the control unit.

3. The secondary battery manufacturing equipment as claimed in claim 2, wherein the height k from the upper surface of the stack table to the center point of the pair of final rollers is set to a height corresponding to a same value as the residual amount and instantaneously required supply amount of the separator material, derived by the control unit.

4. The secondary battery manufacturing equipment as claimed in claim 3, wherein the height h from the upper surface of the stack table to the center point of the pair of hinge rollers and the height k from the upper surface of the stack table to the center point of the pair of final rollers change according to a width of an electrode assembly of the secondary battery.

5. The secondary battery manufacturing equipment as claimed in claim 4, wherein after the separator material is fixed to the clamp, the pair of final rollers further comprise an electrode plate transfer unit seated on the stack table in a state of being maximally spaced apart from the clamp.

6. The secondary battery manufacturing equipment as claimed in claim 5, wherein before the electrode plate transfer unit is seated, the supply length of the separator material is L=L₁+L₂, where L₁ is the length of the separator material from the pair of hinge rollers to the pair of final rollers and L₂ is the length of the separator material from the stack table from the pair of final rollers, and
after the electrode plate transfer unit is seated, L=L₁+L₃, where L₃ is the length of the separator material from the pair of final rollers to the clamp of the stack table after the electrode plate transfer unit is seated on the stack table.

7. The secondary battery manufacturing equipment as claimed in claim 6, wherein the residual amount of the separator material is a value obtained by subtracting, from the supply length of the separator material when the pair of final rollers are located at sections where tension does not occur after changing direction into an opposite direction of an X-axis, the supply length of the separator material when the pair of final rollers are located at an end of the X-axis direction adjacent to the clamp in a state in which the separator material is fixed to the clamp.

8. The secondary battery manufacturing equipment as claimed in claim 7, wherein the residual amount of the separator material is a value obtained by subtracting, from the supply length of the separator material when the pair of final rollers are located at the end of the X-axis direction, which is maximally spaced apart from the clamp, in a state in which the separator material is fixed to the clamp, the supply length of the separator material when changing the direction into the opposite direction of the X-axis after the electrode plate transfer unit is seated.

9. A secondary battery manufacturing equipment comprising:
a supply unit including a supply reel on which a separator material is wound;
a driving unit including a driving motor configured to pull the separator material and a driving roller rotated by the driving motor;
a dancer unit disposed between the supply unit and the driving unit to maintain tension of the separator material;
a pair of hinge rollers disposed on a lower side of the secondary battery manufacturing equipment spaced apart from the driving roller;
a pair of final rollers disposed on the lower side spaced apart from the pair of hinge rollers and reciprocating in the X-axis direction to move the separator material in a zigzag manner;
a stack table disposed on the lower side spaced apart from the pair of final rollers and having a clamp to which one end of the separator material is fixed; and
a control unit configured to derive a supply length of the separator material according to moving positions of the pair of final rollers,
wherein the control unit synchronizes a velocity of the driving roller with an X-axis direction velocity of the pair of final rollers by deriving a supply velocity of the separator material through the supply length of the separator material.

10. The secondary battery manufacturing equipment as claimed in claim 9, wherein the control unit synchronizes the velocity of the driving roller with the X-axis direction velocity of the pair of final rollers by applying the supply velocity of the separator material to a velocity profile of the driving roller.

11. The secondary battery manufacturing equipment as claimed in claim 10, wherein the supply velocity of the separator material over time t, Vₛ(t), is obtained by the following equation:
$$Vs ( t ) = Δ L ( t ) / Δ t = \frac{L ( {t}_{2} ) - L ( {t}_{1} )}{{t}_{2} - {t}_{1}} ,$$
in which before an electrode plate transfer unit is seated, L(t)=L₁(t)+L₂(t), where L₁(t) is the length of the separator material from the pair of hinge rollers to the pair of final rollers, and L₂(t) is the length of the separator material from the stack table from the pair of final rollers, and
after the electrode plate transfer unit is seated, L(t)=L₁(t)+L₃(t), where L₃ (t) is the length of the separator material from the pair of final rollers to the clamp of the stack table after the electrode plate transfer unit is seated on the stack table.

12. The secondary battery manufacturing equipment as claimed in claim 11, wherein the control unit synchronizes the velocity of the driving roller with the X-axis direction velocity of the pair of final rollers according to a method of:
(a) deriving the velocity profile of the pair of final rollers;
(b) deriving a position and swing angle of the pair of final rollers over time;
(c) deriving the supply length of the separator material and a length change over time;
(d) deriving the supply velocity of the separator material; and
(e) synchronizing the velocity of the driving roller with the X-axis direction velocity of the pair of final rollers by applying the supply velocity of the separator material to the velocity profile of the driving roller.

13. A secondary battery comprising:
an electrode assembly manufactured by a secondary battery manufacturing equipment comprising:
a supply unit including a supply reel on which a separator material is wound;
a driving unit including a driving motor configured to pull the separator material and a driving roller rotated by the driving motor;
a dancer unit disposed between the supply unit and the driving unit to maintain tension of the separator material;
a pair of hinge rollers disposed on a lower side of the secondary battery manufacturing equipment spaced apart from the driving roller;
a pair of final rollers disposed on the lower side spaced apart from the hinge rollers and reciprocating in the X-axis direction to move the separator material in a zigzag manner;
a stack table disposed on the lower side spaced apart from the pair of final rollers and having a clamp to which one end of the separator material is fixed; and
a control unit configured to derive a supply length of the separator material according to moving positions of the pair of final rollers,
wherein the control unit synchronizes a velocity of the driving roller with an X-axis direction velocity of the pair of final rollers by deriving a supply velocity of the separator material through the supply length of the separator material;
a can accommodating the electrode assembly; and
a cap assembly having a negative electrode terminal and a positive electrode terminal coupled to the can and electrically connected to the electrode assembly.
